(19) United States
(12) Patent Application Publication
(10) Pub. No.: US 2011/0063095 A1
(43) Pub. Date: Mar. 17, 2011

(54) RF TAG READER AND WRITER

(75) Inventors: Takashi Tomiyama, Shizuoka-ken (JP); Kouichi Sano, Shizuoka-ken (JP)

(73) Assignee: TOSHIBA TEC KABUSHIKI KAISHA, Tokyo (JP)

(21) Appl. No.: 12/877,458

(22) Filed: Sep. 8, 2010

(30) Foreign Application Priority Data
Sep. 14, 2009 (JP) 2009-212414

(51) Int. Cl. G06K 7/01; G05B 11/01; G08C 19/16

(52) U.S. Cl. 340/12.51

(57) ABSTRACT

There is provided an RF tag reader and writer including: a communication unit configured to exchange signals with RF tags by performing a predetermined process unit a plurality of times; a buzzer configured to perform notification by audio output; a read-tag number determination unit configured to determine the number of RF tags which are read by the communication unit every time the predetermined process unit is executed; and a notification control unit configured to change a buzzer sounding frequency corresponding to each predetermined process unit every time each predetermined process unit is completed, in accordance with the number of the read RF tags, which is determined by the read-tag number determination unit for each predetermined process unit.

### CROSS-REFERENCE TO RELATED APPLICATION(S)

This application is based upon and claims the benefit of priority from Japanese Patent Application No, 2009-212414, filed on Sep. 14, 2009; the entire contents of which are incorporated herein by reference.

### FIELD

The embodiment disclosed in this specification relates to a user interface for an RF tag reader and writer for reading RF tags.

### BACKGROUND

Conventionally, a plurality of RF tags are read at once by an RF tag reader/writer when a stock inventory is performed on a plurality of products, to each of which an RF tag is attached. There is a need for intuitively grasping whether the intercommunication state between the RF tag reader/writer and the RF tags is satisfactory when a collective reading is performed on the plurality of RF tags in this manner.

As a technique for responding to such a need, a technique is known of sounding a buzzer once each time one RF tag is read to inform a user of the fact that the RF tag reader/writer read the plurality of RF tags.

However, the RF tag reader/writer with a data transfer speed of 40 kbps can read a maximum of about 75 RF tags per second, if “ISO-18000-6C” is employed as an air interface protocol, for example. Accordingly, if the RF tag reader/writer is configured to sound the buzzer each time each of the plurality of RF tags is read, the buzzer continuously sounds for a time period corresponding to the number of read RF tags regardless of the fact that the reading of the plurality of the RF tags itself was completed in a short time.

This result cause a problem that the user may feel reading speed slow, despite the fact that the actual reading speed of the RF tag reader/writer is much faster than buzzer sound.

### BRIEF DESCRIPTION OF THE DRAWINGS

FIG. 1 is a schematic diagram illustrating a system configuration constituted by an RF tag reader/writer and a PC according to an embodiment.

FIG. 2 is a logic block diagram illustrating a configuration of the RF tag reader/writer.

FIG. 3 is a functional block diagram illustrating a control program of the RF tag reader/writer operated on a CPU according to the embodiment.

FIG. 4 is a diagram illustrating a detail of a host communication processing unit.

FIG. 5 is a diagram illustrating a state transition in the RF tag reader/writer.

FIG. 6 is a functional block diagram illustrating a detail of the function of a software wireless processing unit.

FIG. 7 is a flow chart illustrating a detail of an RF tag reading process using the software wireless processing unit.

FIG. 8 is a diagram illustrating a control table showing setting values for a sounding time period and a sounding frequency of a buzzer.

FIG. 9 is a diagram illustrating a control for changing the sounding frequency of the buzzer corresponding to respective inventory rounds.

FIG. 10 is a diagram illustrating a control for changing the sounding time period of the buzzer corresponding to each one of the RF tags.

FIG. 11 is a diagram illustrating a control for changing the sounding time period of the buzzer (the length of the sound) corresponding to the respective inventory rounds in accordance with the number of the RF tags read in the respective inventory rounds.

FIG. 12 is a diagram illustrating a buzzer sounding control for handling the case where the sounding time period of the buzzer for one RF tag becomes too short.

FIG. 13 is a timing chart for the buzzer sounding control shown in FIG. 12.

### DETAILED DESCRIPTION

According to an embodiment, an RF tag reader and writer generally includes a communication unit configured to exchange signals with RF tags by performing a predetermined process unit a plurality of times; a buzzer configured to perform notification by audio output; a read-tag number determination unit configured to determine the number of RF tags which are read by the communication unit every time the predetermined process unit is executed; and a notification control unit configured to change a buzzer sounding frequency, corresponding to each predetermined process unit in accordance with the number of the read RF tags, which is determined by the read-tag number determination unit for each predetermined process unit every time each predetermined process unit is completed.

In addition, according to an embodiment, an RF tag reader and writer generally includes a communication unit configured to exchange signals with RF tags by performing a predetermined process unit a plurality of times; a buzzer configured to perform notification by audio output; a read-tag number determination unit configured to determine the number of RF tags which are read in the communication unit every time the predetermined process unit is executed; and a notification control unit configured to change a buzzer sounding time period corresponding to each predetermined process unit in accordance with the number of the read RF tags, which is determined by the read-tag number determination unit for each predetermined process units every time each predetermined process unit is completed.

In addition, according to an embodiment, an RF tag reader and writer generally includes a communication unit configured to exchange signals with RF tags by performing predetermined process units a plurality of times; a buzzer configured to perform notification by audio output; a read-tag number determination unit configured to determine the number of RF tags which are read by the communication unit every time the predetermined process unit is executed; and a notification control unit configured to sound the buzzer corresponding to each predetermined process unit, a predetermined number of times in accordance with the number of the read RF tags, which is determined by the read-tag number determination unit for each predetermined process unit, every time each predetermined process unit is completed and for setting a sounding time period for each predetermined buzzer sounding time based on the number of the read RF tags, which is determined by the read-tag number determination unit.

In addition, according to an embodiment of the invention, an RF tag reader and writer generally includes a communication unit configured to exchange signals with RF tags; a buzzer configured to perform notification by audio output; a read-tag number determination unit configured to determine the number of RF tags which are read by the communication unit; and a notification control unit configured to change a buzzer sounding frequency in accordance with the number of the read RF tags, which is determined by the read-tag number determination unit.

In addition, according to an embodiment of the invention, an RF tag reader and writer generally includes a communication unit configured to exchange signals with RF tags, a buzzer configured to perform notification by audio output, a read-tag number determination unit configured to determine the number of RF tags which are read in the communication unit, and a notification control unit configured to change a buzzer sounding time period in accordance with the number of the read RF tags, which is determined by the read-tag number determination unit.

Hereinafter, a description will be made of the embodiment with reference to the accompanying drawings.

Hereinafter, an RF tag reader and writer according to the embodiment of the present invention will be described with reference to the accompanying drawings.

Here, a description will be made of the configuration and the operations of the RF tag reader and writer of the embodiment while exemplifying a stock inventory operation for a stock of a plurality of commercial products, to each of which an RF tag is attached, as an embodiment of the present invention.

### (Configuration of RF Tag Reader/Writer)

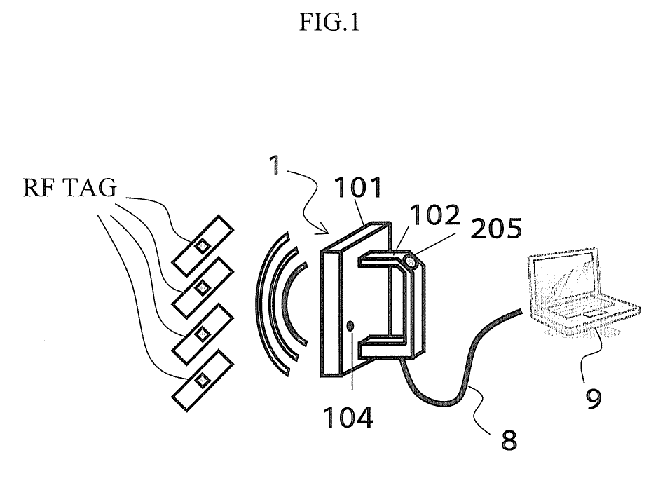

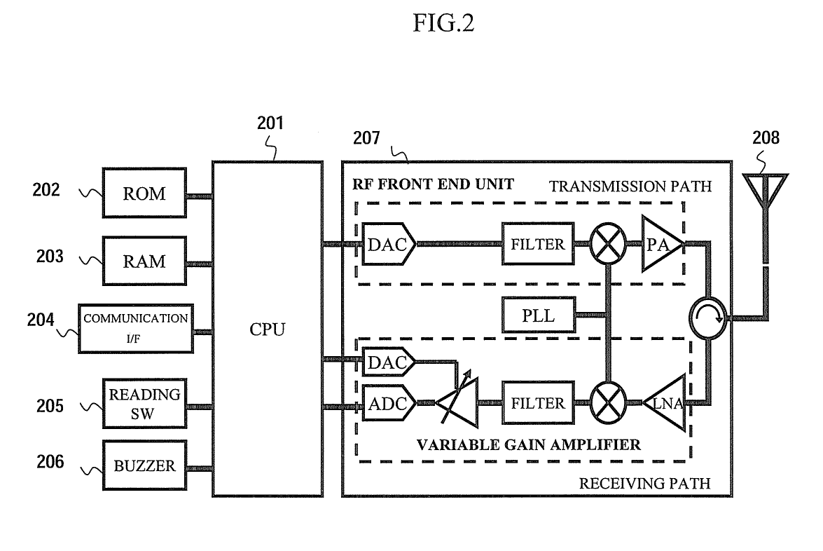

First, a basic configuration of the RF tag reader/writer according to the embodiment of the present invention will be described with reference to FIGS. 1 and 2.

FIG. 1 is a schematic diagram illustrating a system configuration constituted by an RF tag reader/writer 1 of the embodiment of the present invention and a PC (Personal Computer) 9. FIG. 2 is a logic block diagram illustrating a configuration of the RF tag reader/writer 1.

The RF tag reader/writer 1 of this embodiment is a handheld-type reader and writer which can be easily carried. The RF tag reader/writer 1 and the PC 9 can communicate with each other via a communication cable or the like.

The RF tag reader/writer 1 of this embodiment includes, for example, a CPU 201, a ROM 202, a RAM 203, a communication interface (communication I/F) 204, a reading switch (reading SW) 205, a buzzer 206, an RF front end unit 207, and an antenna 208. The above-mentioned components from the CPU 201 to the antenna 208 are accommodated in a case body 101 made of plastic, for example. The case body 101 is provided with a handle 102 to be used for holding the RF tag reader/writer 1.

A user who uses the RF tag reader/writer 1 can hold the RF tag reader/writer 1 by gripping the handle 102. The reading switch 205 is arranged in the handle 102. The user starts the reading operation of RF tags as reading target by pressing the reading switch 205. In addition, a hole portion 104 for guiding a buzzer sound, which is generated by sounding the buzzer 206, to the outside of the case body 101 is provided in the case body 101.

The communication interface 204 is used for receiving commands from a host or sending responses to the host. The reading switch 205 is used for instructing the CPU 201 to start the reading of the RF tags. The buzzer 206 is used for notifying the user of the reading state of the RF tags. The RF front end unit 207 and the antenna 208 are used for exchanging radio waves necessary for the intercommunication with the RF tags.

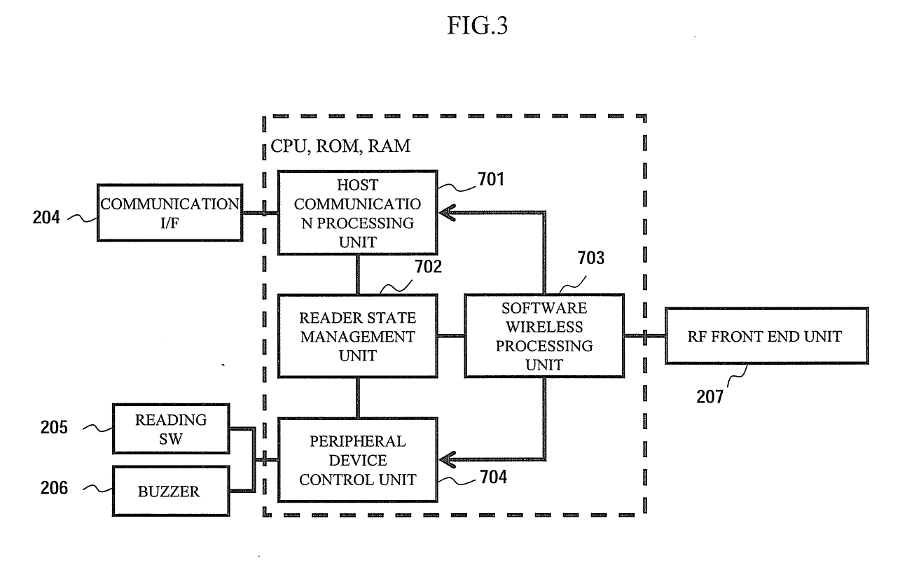

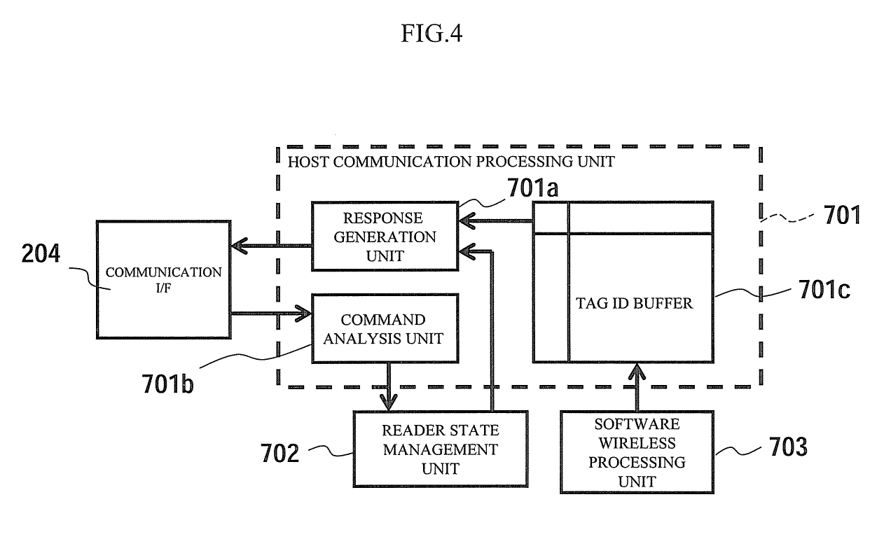

FIG. 3 is a functional block diagram for illustrating a control program of the RF tag reader/writer 1 operated on the CPU 201 according to the embodiment. As shown in FIG. 3, the control program of the RF tag reader/writer 1 can implement the various types of functional blocks such as a host communication processing unit 701, a reader state management unit 702, a software wireless processing unit 703, and a peripheral device control unit 704. The host communication processing unit 701 includes a command analysis unit 701b for receiving commands from the PC 9 as a host as shown in FIG. 4 and determining the process contents to be executed, a tag ID buffer 701c for accumulating tag ID reading result information which is read from the RF tags, and a response generation unit 701a for organizing a command execution result as a response deliver message and sending it to the host.

The reader state management unit 702 manages which one of a stand-by state and an RF tag reading state the RF tag reader/writer 1 is in. This control program of the RF tag reader/writer 1 is stored in the ROM 202, and the CPU 201 reads this program from the ROM 202 and uses the RAM 203 as a main memory to perform a process of reading IDs of the RF tags in response to the command from the host.

### (RF Tag Reading Process)

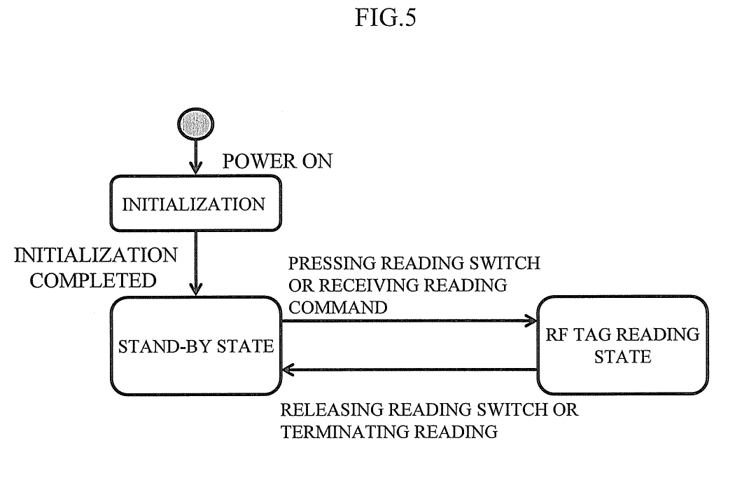

Next, a description will be made of the RF tag reading process according to the embodiment of the present invention with reference to FIGS. 5 to 12.

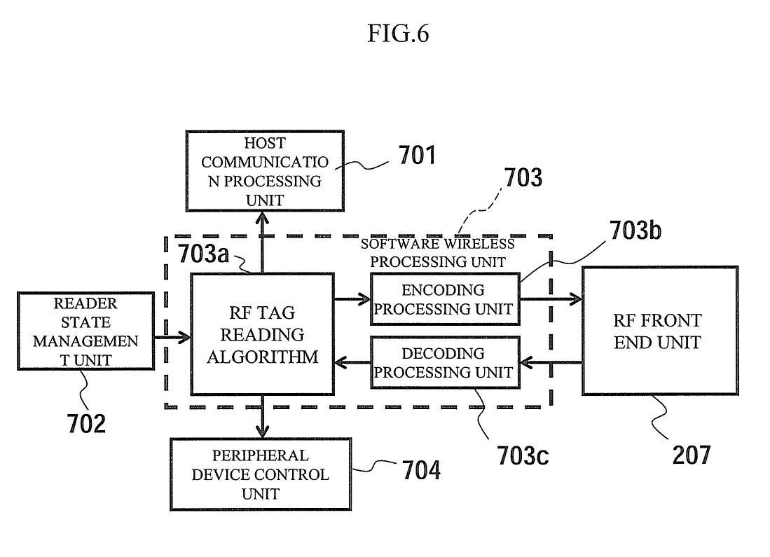

FIG. 5 is a diagram illustrating a state transition in the RF tag reader/writer 1. FIG. 6 is a functional block diagram for illustrating a detail of the function of the software wireless processing unit 703.

The RF tag reader/writer 1 enters a stand-by state when power is turned on from an OFF state and initialization is completed. Then, the RF tag reader/writer 1 shifts to an RF tag reading state if a reading start command is received from the host (such as the PC 9) via the communication interface 204, or if the reading switch 205 is pressed.

After the RF tag reader/writer 1 shifts to the RF tag reading state, the CPU 201 reads the RF tag using the software wireless processing unit 703.

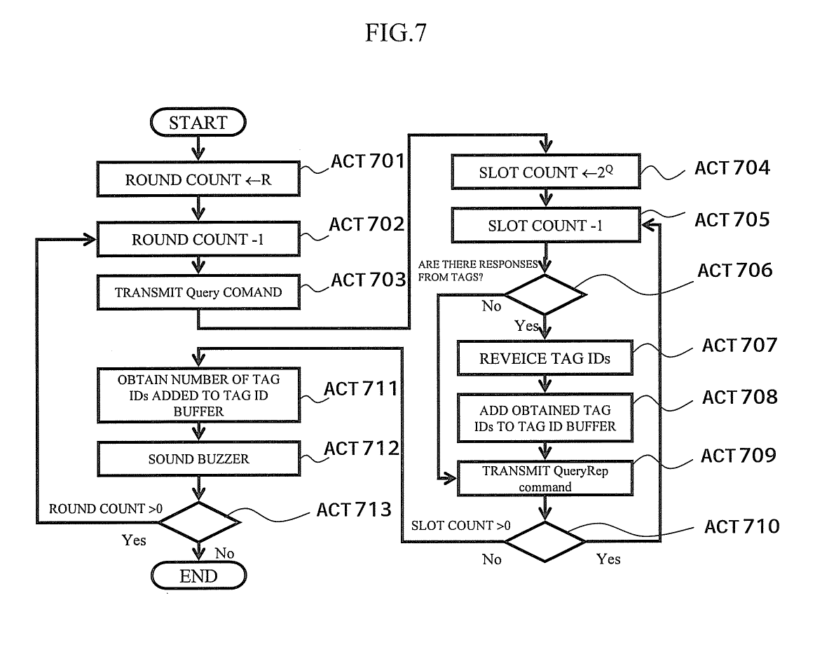

FIG. 7 is a flow chart illustrating a detail of the RF tag reading process using the software wireless processing unit 703. In the flow chart of FIG. 7, a case is assumed in which ISO18000-6C is employed as an air interface protocol necessary for the intercommunication between the RF tag reader/writer 1 and the RF tags.

### (Description of Slot, Reading Round, and Reading Cycle)

A description will be made of some terms before describing the flow chart of FIG. 7.

First, in 15018000-6C, the RF tag reader/writer sends a “Query” command (a command for ordering the tag ID transmission) to an RF tag group and thereby starts the inventory (reading) of the tag IDs. The “Query command” includes a “Q value” as a parameter. The “Q value” is a value for determining the number of slots to be used for avoiding collisions of the tag responses. Next, a period from the time point of sending the Query command to the time point of sending the next Query command is referred to as an inventory round (reading round) (corresponding to the predetermined process unit). A plurality of slots, which are determined by the Q value, exist in one inventory round. Here, “time period for executing the predetermined process unit” is a time period for executing one inventory round. In addition, a QueryRep command is a command for decrementing the slot counter included in each of the RF tags during an inventory round which starts from the Query command. If the RF tag receives the Query command, the RF tag sets the slot counter for avoiding collisions in the RF tag. The value set for this slot counter in the RF tag is a random number with an upper limit of 2 to the Q-th power, which is generated by a random number generator in the RF tag. If the RF tag receives the QueryRep command, the RF tag decrements this slot counter by one. When the slot counter becomes 0, the RF tag sends a response to the RF tag reader/writer 1.

In this specification, one or a plurality of inventory rounds are collectively defined as a unit of inventory cycle (reading cycle) in order that the RF tag reader/writer 1 manages the reading processes. The software wireless processing unit 703 (communication unit) performs plural times of the inventory rounds, each of which is a predetermined process unit, and thereby exchanges signal with the RF tags.

Returning to FIG. 7, a detailed description will be made of the RF tag reading process with reference to the flow chart. ACT 701 to ACT 713 in FIG. 7 are processes in the inventory cycle, and ACT 704 to ACT 710 among them are processes in the inventory round.

First, the CPU 201 sets an initial value R of a “round count” for counting the number of times of the inventory round (ACT 701). Here, it is assumed that the round count is counted by reduction in numbers. For example, if three times of reading rounds are performed for one tag reading command from the host, the initial value of the round count becomes three. Then, the round count is decremented by one (ACT 702), and the Query command is sent to the RF tag group within the intercommunication range of the antenna 208 (ACT 703). This Query command is encoded by an encoding processing unit 703b in the software wireless processing unit 703, modulated by the RF front end unit 207, and sent from the antenna 208.

The CPU 201 sends the Query command, and then sets the slot number for the slot count using the Q value included in the parameter of the Query command (ACT 704), decrements the slot count by one (ACT 705), and waits for the responses from the RF tags (ACT 706).

If there are response from the RF tag (Yes in ACT 706), the antenna 208 receives the response from the RF tag, where a detailed description of the protocol is omitted. Then, the RF front end unit 207 demodulates the responses, a decoding processing unit 703c of the software wireless processing unit 703 decodes the demodulated responses, and thereby ID information of the RF tags is obtained (ACT 707).

The CPU 201 obtains the ID information of the RF tags, which were decoded by the decoding processing unit 703c, and then adds the tag IDs to the tag ID buffer 701c of the host communication processing unit 701 (ACT 708). Thereafter, the CPU 201 sends a QueryRep command to the RF tag group (ACT 709). If there is no response from the RF tags (No in ACT 706), the CPU 201 moves on to ACT 709 from ACT 706 and sends the QueryRep command.

If the slot count is a positive value after the QueryRep command was sent (Yes in ACT 710), the CPU 201 returns to ACT 705 and repeats the processes from ACT 705 to ACT 710 until the slot count reaches zero.

If the slot count is zero in ACT 710 (No in ACT 710), the number of the tag IDs added to the tag ID buffer 701c of the host communication processing unit 701 is obtained (ACT 711). The number of the tag IDs added to the tag ID buffer 701c corresponds to the number of the tag IDs read in one inventory round from ACT 704 to ACT 710. As described above, the CPU 201 (read-tag number determination unit) determines the number of RF tags read every time the software wireless processing unit 703 executes the predetermined processing unit.

Subsequently, the CPU 201 sounds the buzzer 206 via the peripheral device control unit 704 in accordance with the number of the tag IDs obtained in ACT 711 (ACT 712).

### (Buzzer Sounding Process)

The buzzer 206 may be a “self-excited buzzer” provided with a built-in oscillation circuit by which the buzzer itself oscillates at a specific frequency or may be a “separately-excited buzzer” to which a portion outside of the buzzer, such as the CPU 201, supplies a signal for exciting and oscillating the buzzer. Here, a description will be made of the buzzer sounding process using the separately-excited buzzer to which the CPU 201 supplies a signal.

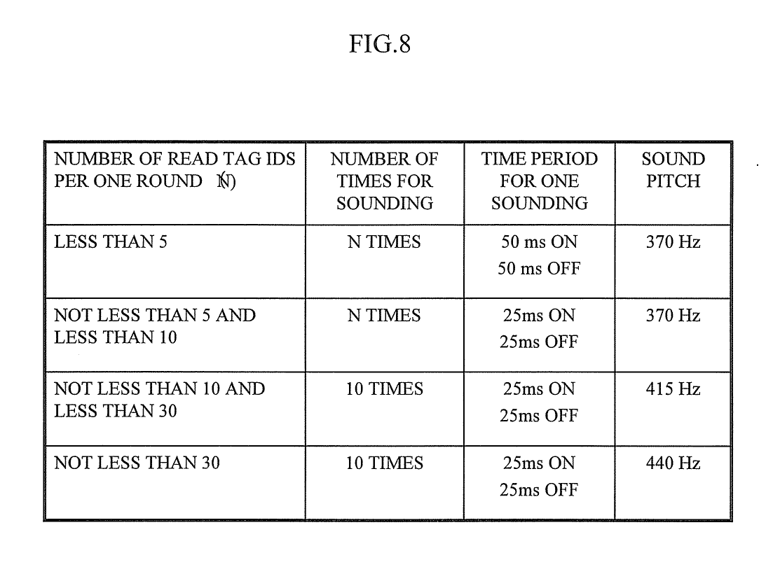

For the separately-excited buzzer, the sound frequency, that is, the sound pitch of the buzzer 206 can be determined by the frequency of the signal to be supplied from the CPU 201. If such a separately-excited buzzer 206 is used, the CPU 201 determines the number of times for sounding, the time period for sounding (length of the sound), and sound pitch of the buzzer 206 in accordance with a table shown in FIG. 8, for example, depending on the number of the tag IDs for each single inventory round, which was obtained in ACT 711, and sounds the buzzer 206 in ACT 712 in the flow chart of FIG. 7. For example, the number of the tag IDs for each single inventory round is set to be N. When the number N of the tag IDs is less than 5, the number of times for sounding the buzzer 206 (which is counted such that a pair of ON and OFF operations corresponds to one time) is set to be N, both the time periods for the ON state and the OFF state for each one sounding are set to be 50 ms, and the sound pitch is set to be 370 Hz. When the number N of the tag IDs is not more than 10, the number of times for the sounding and the sound pitch are set to be the same as those when the number N is less than 5, and both the time periods for the ON state and the OFF state for each one sounding are shortened to 25 ms.

With such a configuration, it is possible to suppress the total of the buzzer sounding time periods to not more than 500 ms even if the number of tags increases. A time period required for obtaining about 50 tag IDs at a link speed of 40 kbps (time period for executing the predetermined process unit) is estimated to be about 600 ms. Accordingly, if the total of the buzzer sounding time periods (the longest time period for which the buzzer may continuously sound) is suppressed to not more than 500 ms, it is possible to complete the sounding of the buzzer 206 before the next inventory round is terminated and to prevent the buzzer sound from being delayed as compared with the actual reading speed. Accordingly, it is possible to prevent the user from getting the misunderstanding that “the reading speed is slow”. In addition, in regard to the sounding process of the buzzer 206, it is preferable to cause a hardware timer (not illustrated) instead of the CPU 201 to execute the sounding process of the buzzer 206 so as not to consume the process time of the CPU 201 during the sounding.

Moreover, when the number N of the tag IDs is not less than 10 and is less than 20, the number of times for sounding the buzzer is fixed to 10 times, both the time periods for the ON state and the OFF state for each one sounding are set to be 25 ms, and the sound pitch is raised up to 415 Hz. Such a setting is made for representing through the sound pitch that more tags are being read because humans cannot hear and distinguish the number of sounding times when the sounding time periods become too short. Furthermore, when the number N of the tag IDs is increased to not less than 30, it is possible to represent that more tags are being read by setting the number of times for the sounding and the time period for the sounding to be the same as those when the number N is not less than 10 and is less than 20, and raising the sound pitch to 440 Hz.

The CPU 201 instructs the peripheral device control unit 704 to perform the sounding for the tags in ACT 712 and then confirms that the round count is a positive value (ACT 713). If the round count is a positive value (Yes in ACT 713), the process returns to ACT 702, and the processes from ACT 702 to ACT 713 are repeated until the round count reaches zero. If the round count is zero in ACT 713 (No in ACT 713), the CPU 201 terminates an RF tag reading algorithm 703a in the software wireless processing unit 703, and returns the process to the reader state management unit 702.

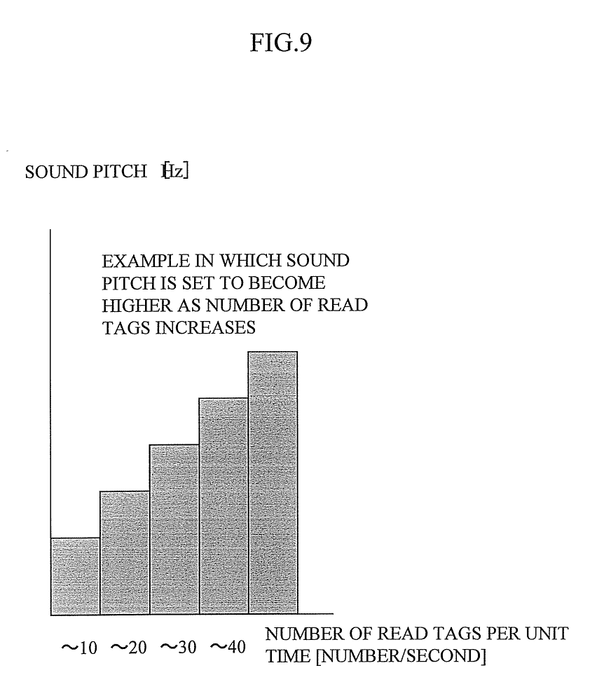

As described above, the CPU 201 (notification control unit) of this embodiment can change the frequency (sound pitch) for sounding the buzzer 206 corresponding to each of the inventory rounds in accordance to the number of the read RF tags, which is determined by the CPU 201 (read-tag number determination unit) for each of the predetermined process units, every time the inventory round (predetermined process unit) is completed. FIG. 9 is a diagram illustrating a control for changing the sounding frequency of the buzzer 206 corresponding to each of the inventory rounds.

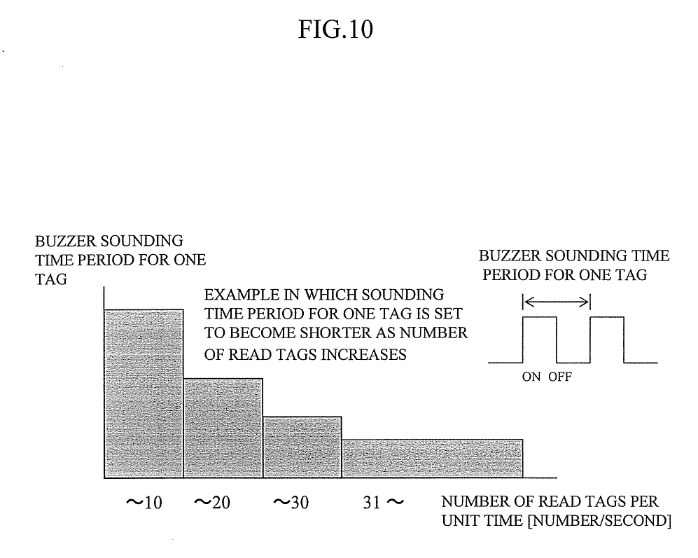

In addition, the CPU 201 (notification control unit) of the embodiment can sound the buzzer 206 corresponding to each of the inventory rounds by a predetermined number of times determined in accordance with the number of the read RF tags, which is determined by the CPU 201 for each of the inventory rounds, every time the inventory round is completed, and set the time period for sounding the buzzer 206 for each one of the predetermined number of times based on the number of the read RF tags, which is determined by the CPU 201. FIG. 10 is a diagram illustrating a control for changing the time period for sounding the buzzer 206 corresponding to each one RF tag. In addition, CPU 201 determines the “predetermined number of times” in accordance with the number of the read RF tags based on, for example, a data table stored in the ROM 202.

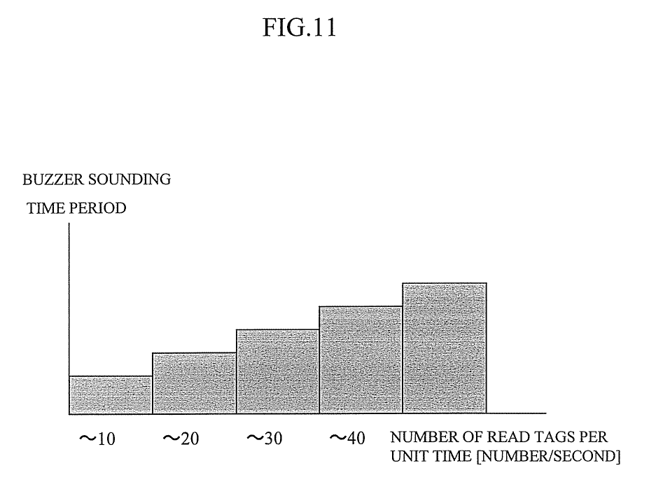

In addition, in the embodiment, the CPU 201 (notification control unit) can change the time period for sounding the buzzer 206 corresponding to each of the inventory rounds in accordance with the number of the read RF tags, which is determined by the CPU 201 for each of the inventory rounds, every time each of the inventory rounds is completed. FIG. 11 is a diagram illustrating a control for changing the time period (length of the sound) for sounding the buzzer 206 corresponding to each of the inventory rounds in accordance with the number of the read RF tags in each of the inventory rounds. If the number of the read RF tags is increased, and a time period for sounding for one RF tag becomes too short, humans cannot hear and distinguish the number of times for sounding, and the buzzer sounds as if it is continuously sounded. Accordingly, FIG. 11 shows a configuration capable of representing that more RF tags are being read, by a continuous sounding time period instead of sounding the buzzer a number of times.

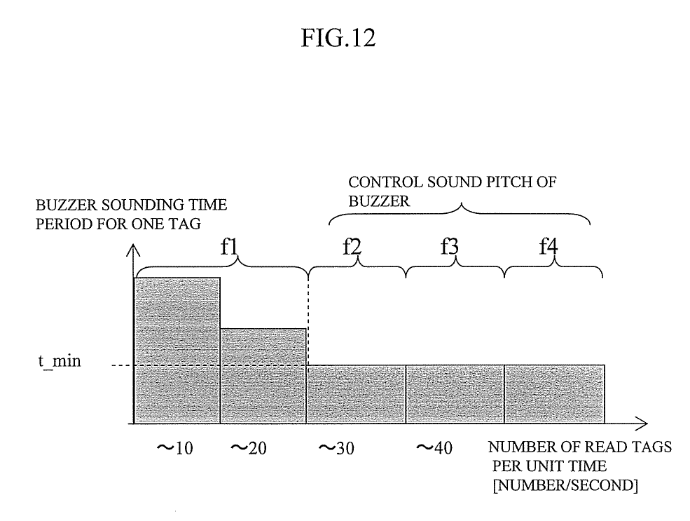

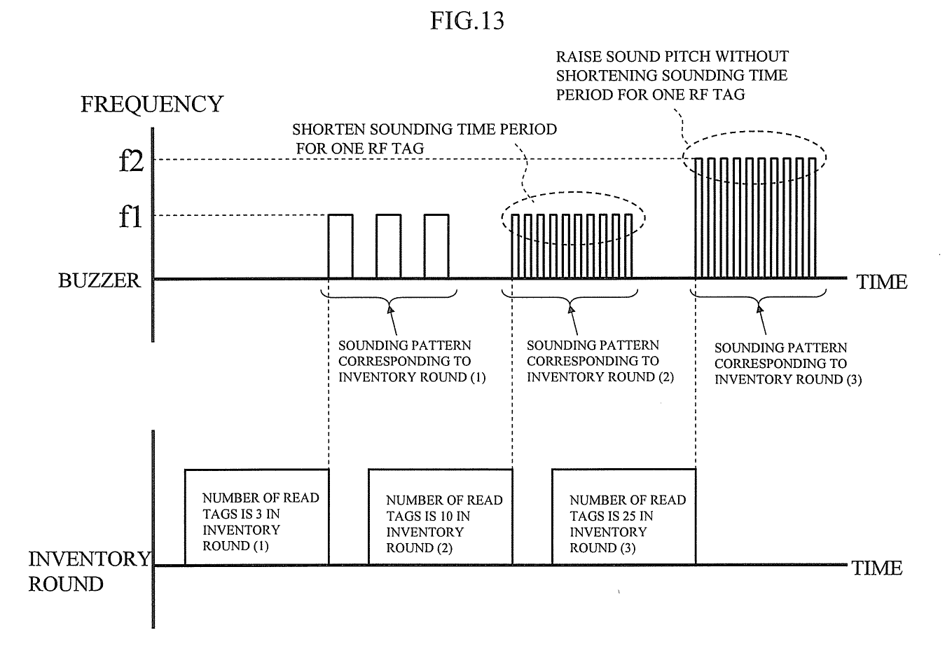

Furthermore, as for the inventory round in which the each time period for sounding the buzzer 206 becomes shorter than a predetermined time, the CPU 201 (notification control unit) of the embodiment can change the frequency for sounding the buzzer 206 corresponding to the inventory round in accordance with the number of the read RF tag, which is determined by the CPU 201 for the inventory round. FIG. 12 is a diagram illustrating a buzzer sounding control for handling the case in which a buzzer sounding time period for one RF tag becomes too short. FIG. 13 is a timing chart for the buzzer sounding control shown in FIG. 12.

### (Transmission of Tag Reading Result)

If the CPU 201 terminates the RF tag reading, the CPU 201 causes the host communication processing unit 701 to organize the tag ID reading result as a response deliver message and transmits the response deliver message to the host (PC 9, or the like). If the transmission of the response deliver message is completed, the CPU 201 allows the state of the RF tag reader/writer 1 in the reader state management unit 702 to shift to a stand-by state and waits for the reception of the next command.

In addition, according to the embodiment, the timing of the buzzer sounding is set before ACT 713 in the flow chart of FIG. 7. However, if it is desired to sound the buzzer 206 after executing the inventory rounds a plurality of times, it is necessary to sound the buzzer 206 after (No in ACT 713). It is needless to say that even in such a case, it is possible to achieve the effects according to the embodiment of the present invention.

If the number of the read RF tags per unit time is used, the CPU 201 measures the execution time of one inventory round, divides the number of the Tag IDs read in one round by the time period for one round, and thereby calculates the “number of read RF tags per unit time”.

In addition, the sound pitch at the time of sounding the buzzer 206 is set in accordance with the number of the read RF tags in each inventory round according to the embodiment. However, it is also applicable to use a value which can be obtained by dividing the number of the read RF tags in each inventory round by the slot number obtained from the Q value. As a result, the user can intuitively comprehend whether the RF tag group existing within the intercommunication range of the antenna 208 is effectively read with the Q value used in the Query command, more easily. In other words, by normalizing the number of the read RF tags based on the slot number, it is possible to comprehend the level of the reading efficiency even when the Q value is changed.

In the above embodiment, the sounding time period and the sound pitch of the buzzer 206 are set in accordance with the number of the read RF tags in each inventory round. However, the present invention is not necessarily limited thereto. For example, it is needless to say that another configuration is also applicable in which the sounding time period and the sound pitch of the buzzer 206 are controlled based on the total number of the read RF tags, which is obtained by summing up the numbers of the RF tags read through a plurality of inventory rounds.

According to the embodiment as described above, the user can comprehend in real time whether the number of the RF tags, which are being read in each inventory round (that is, in each unit time), is decreased depending on the buzzer sounding manner. As a result, it is possible to achieve an advantage in that the user can intuitively comprehend that readable RF tags are decreased in the area where the user is currently performing the reading operation, for example.

If the sounding of the buzzer for each one inventory round is complicated, or if it is difficult to hear the change of the buzzer sound because of the excessively short time intervals between buzzer soundings, it is possible to make it easier to hear the change in the sounding time period and the sounding frequency of the buzzer sound by setting a unit for sounding the buzzer to be every several inventory rounds.

Furthermore, it is possible to provide a program which is caused to execute the above-mentioned respective operations in a computer constituting the RF tag reader and writer. In the embodiment, the description was made of the case where the program for executing the functions implementing the present invention is stored in advance in a storage region provided in the device. However, the present invention is not limited thereto, and the same program may be downloaded to the device through a network, or the same program stored in a computer-readable recording medium may be installed to the device. Any type of recording medium can be used as long as it can store the program and can be read by a computer. Specifically, examples of the recording medium include an internal storage device, which is mounted inside a computer, such as a ROM or a RAM, a portable storage medium such as a CD-ROM, a flexible disc, a DVD disc, a magneto-optical disc or an IC card, a database for holding a computer program, another computer and a database thereon, and an online transmission medium. In addition, the functions obtained in advance by installing or downloading may be implemented while cooperating with an OS (Operating System) or the like in the device.

In addition, the program may partially or entirely be an execution module which is dynamically generated.

As described above in detail, according to the technique disclosed in this specification, it is possible to provide a technique with which the user can easily comprehend the reading state of the RF tags in the RF tag reader and writer in real time.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An RF tag reader and writer comprising:
a communication unit configured to exchange signals with RF tags by performing a predetermined process unit a plurality of times;
a buzzer configured to perform notification by audio output;
a read-tag number determination unit configured to determine the number of RF tags which are read by the communication unit every time the predetermined process unit is executed; and
a notification control unit configured to change a buzzer sounding frequency corresponding to each predetermined process unit every time each predetermined process unit is completed, in accordance with the number of read RF tags, which is determined by the read-tag number determination unit for each predetermined process unit.

2. An RF tag reader and writer comprising:
a communication unit configured to exchange signals with RF tags by performing a predetermined process unit a plurality of times;
a buzzer configured to perform notification by audio output;
a read-tag number determination unit configured to determine the number of RF tags which are read by the communication unit every time the predetermined process unit is executed; and
a notification control unit configured to change a buzzer sounding time period corresponding to each predetermined process unit every time each predetermined process unit is completed, in accordance with the number of the read RF tags, which is determined by the read-tag number determination unit for each predetermined process unit.

3. An RF tag reader and writer comprising:
a communication unit configured to exchange signals with RF tags by performing a predetermined process unit a plurality of times;
a buzzer configured to perform notification by audio output;
a read-tag number determination unit configured to determining the number of RF tags which are read by the communication unit every time the predetermined process unit is executed; and
a notification control unit configured to sound the buzzer corresponding to each predetermined process unit, a predetermined number of times in accordance with the number of the read RF tags, which is determined by the read-tag number determination unit for each predetermined process unit, every time each predetermined process unit is completed and for setting a sounding time period for each predetermined buzzer sounding time based on the number of the read RF tags, which is determined by the read-tag number determination unit.

4. The RF tag reader and writer according to claim 3,
wherein for the process unit in which each buzzer sounding time period is shorter than a predetermined time period, the notification control unit changes a buzzer sounding frequency corresponding to the process unit in accordance with the number of the read RF tags, which is determined by the read-tag number determination unit for the process unit.

5. The RF tag reader and writer according to claim 1,
wherein the communication unit transmits a Query command for ordering the RF tags to transmit tag IDs, and
wherein when it is assumed that a period from a time point when the Query command is sent to a time point when the next Query command is transmitted is one round, a time period for executing the predetermined process unit is a time period for executing a tag reading cycle which includes at least one round.

6. RF tag reader and writer according to claim 1,
wherein the notification control unit changes the buzzer sounding frequency in accordance with the ratio between a value relating to a slot number included in a Query command transmitted from the communication unit and a number of the RF tags determined by the read-tag number determination unit corresponding to one execution of the predetermined process unit.

7. The RF tag reader and writer according to claim 1,
wherein the longest time period for which the buzzer may sound is set to be shorter than a time period for executing the predetermined process unit.

8. An RF tag reader and writer comprising:
a communication unit configured to exchange signals with RF tags;
a buzzer configured to perform notification by audio output;
a read-tag number determination unit configured to determine the number of RF tags which are read by the communication unit; and
a notification control unit configured to change a buzzer sounding frequency in accordance with the number of the read RF tags, which is determined by the read-tag number determination unit.

9. An RF tag reader and writer comprising:
a communication unit configured to exchange signals with RF tags;
a buzzer configured to perform notification by audio output;
a read-tag number determination unit configured to determine the number of RF tags which are read by the communication unit; and
a notification control unit configured to change a buzzer sounding time period in accordance with the number of the read RF tags, which is determined by the read-tag number determination unit.
